(19) United States
(12) Patent Application Publication
(10) Pub. No.: US 2012/0171492 A1
(43) Pub. Date: Jul. 5, 2012

(54) ENCAPSULATION OF REACTIVE COMPONENTS FOR 1-K SYSTEMS USING COAXIAL DIES

(75) Inventors: Mandy Muehlbach, Seligenstadt (DE); Patrick Stenner, Hanau (DE); Silke Suhr, Albstadt-Alzenau (DE); Peter Neugebauer, Limburg (DE); Heike Heeb, Bickenbach (DE); Guenter Schmitt, Darmstadt (DE); Peter Reinhard, Dreieich-Dreieichenhain (DE)

(73) Assignee: EVONIK ROEHM GmbH, Darmstadt (DE)

(21) Appl. No.: 13/392,991

(22) PCT Filed: Sep. 7, 2010
(86) PCT No.: PCT/EP2010/063068

§ 371 Date: Feb. 28, 2012

(30) Foreign Application Priority Data
Oct. 30, 2009 (DE) 10 2009 046 244.9

(51) Int. Cl. B32B 5/16; B29B 9/00; C09K 3/00

(52) U.S. Cl. 428/402.2; 252/186.25; 264/7

(57) ABSTRACT

The invention relates to the production of core-shell particles for encapsulating reactive components for single-component resin systems. In particular, the invention relates to the encapsulation of radical initiators such as peroxides. The invention further relates to a method for the 100% encapsulation of reactive components, whereby novel, storage-stable resin systems can be provided. At the same time, the core-shell particles are designed such that they can be opened nearly completely, easily and quickly during application, but have sufficient storage and shear stability before application.

### FIELD OF THE INVENTION

The present invention embraces the preparation of core-shell particles for the encapsulation of reactive components for one-component resin systems. The present invention more particularly embraces the encapsulation of radical initiators such as peroxides. The invention further embraces a process for the 100% encapsulation of the reactive component, thereby allowing the provision of innovative, storage-stable resin systems. At the same time the core-shell particles are constructed such that on application they can be opened easily, quickly, and virtually completely, but prior to the application they have a sufficient storage and shear stability.

One-component reactive systems can be employed in a multitude of sectors. Such systems find particular significance in the sector of the sealants, adhesives, and with plugging resins, as described in DE 43 15 788, for example. Fields which go beyond these, however, in the medical sector, such as in the dental sector, for example, in coatings such as paints and varnishes or in reactive resins such as road markings or industrial flooring, for example, may hold potential application for curing one component systems.

For the provision of one-component systems there are a plurality of technical solutions. First, the curing mechanism may be initiated by a component which diffuses in subsequently, preferably from the environment, such as atmosphere humidity or oxygen. Moisture-curing systems, often isocyanate- or silyl-based, however, are not suitable for every application. In the case of very thick layers or applications in the wet sector, for example, moisture-curing systems are less suitable. Moreover, such systems cure only very slowly to completion, often not until weeks have elapsed. In contrast, for road markings, for example, rapid cure rates are required.

A second technical solution for the provision of one-component, storage-stable 1-component systems is the encapsulation of a reaction component such as, for example, of a crosslinker, a catalyst, an accelerator or an initiator.

Rapid cure mechanisms of these kinds play a large part particularly for reactive resins. Reactive resins usually cure by means of radical reaction mechanisms. The initiator system in the majority of these cases consists of a radical chain initiator, usually of a peroxide or a redox system, and of an accelerator, usually of amines. Both components of the system may each be encapsulated. A problem in the prior art, however, is the release mechanism by which the capsules are ruptured, dissolved or otherwise opened.

### PRIOR ART

With encapsulated systems the moment of release of the reactive component is controllable. The systems usually comprise core-shell particles whose shell is impermeable to the active ingredient and must be opened for the release of the active ingredient. Furthermore, the core must not be soluble in the shell, and the shell must not be soluble in the medium in which the core-shell particle is located. A range of release mechanisms are known. They may be based either on external introduction of energy or on alteration of chemical formulation parameters such as moisture content or pH. Release by introduction of water or solvent, however, has the drawback, that such methods either function only very slowly or must take place by addition. In the case of component addition, however, the features and drawbacks of a 2-component system would apply. In the case of the diffusion of the second component, in the form of moisture, for example, the release would be too slow for applications such as, for example, as road marking.

Systems have now become established in which the opening of the shell is accomplished by pressure, or by a mechanical introduction of energy such as by shearing. To this end, a variety of coatings for the encapsulation of reactive components such as initiators are described. These systems are based on organic, high-build coatings. A drawback of such systems of the prior art is usually the shear instability of the shells. Thus core-shell particles of this kind are usually difficult to incorporate into a 1-K (1-component) formulation, since the shearing energy that accompanies mixing is too high for the relatively unstable shells. This effect is usually countered by producing particles which have a diameter of less than 500 μm. The drawback of small particles, however, is that a relatively small amount of filling material, such as a peroxide dispersion, for example, requires a comparatively large amount of shell material, or a significantly greater number of particles. The aim for a 1-K formulation of this kind ought therefore to be a minimal fraction of the shell material in relation to the reactive component. Moreover, the rupturing of relatively small particles is more difficult than that of their relatively large counterparts. This can lead to incomplete provision of the reactive component and, under certain circumstances, may necessitate an even higher formulating fraction.

A decidedly old technology for the preparation of microparticles or core-shell particles with a filling which comprises reactive components is the emulsion polymerization of styrene or (meth)acrylates. A drawback of such a process is that components which are soluble in water, even only slightly, cannot be completely encapsulated. A relatively broad distribution of the particle sizes, and formation of agglomerates, may also prove to be drawbacks.

Examples of such organic shell materials for the encapsulation of reactive components, or solutions or dispersions, are, in particular, polymers obtained naturally, such as gelatin, carrageen, gum arabic or xanthan, and chemically modified materials on this basis, such as methyl cellulose or gelatin polysulfate. WO 98 26865 describes the preparation of core-shell particles with encapsulated acids and shells of gelatin and other natural polymers. The capsules, with a size of not more than 100 μm, are produced by treating the mixture with ultrasound. With a process of this kind, however, the influence over the particle size is small. Furthermore, the encapsulation of reactive components that are poorly soluble in water, or their solutions, is not possible.

U.S. Pat. No. 4,808,639 gives an overview of various established encapsulation methods employing such natural polymers. For the synthesis more particularly of relatively large particles, having a diameter of more than 500 μm, the liquid-jet method is recited, in which a liquid jet is introduced into a precipitation medium, and individual particles cure in the process. A drawback of this prior-art method, however, is that the individual particles are usually formed by tearing-apart of the introduced jet in the precipitation medium, and, accordingly, the resultant particles are not spherical and may have a broad size distribution. Particles which are not spherical, however, are less stable than those which are ideally spherical, and so may tend to rupture prematurely in a formulation under shear. Moreover, with the conventional liquid-jet method, a mixture is added which is composed of the component to be encapsulated and of the shell material. This can only work, however, if the component has a lower miscibility with the precipitation medium than the shell material. This circumstance further limits the liquid-jet method.

Another method of encapsulation is coacervation, in which chemical or physical parameters of a colloidal solution result in phase separation. By means of appropriate operational parameters it is possible to vary the method in such a way that particles are formed. If a component for encapsulation has been dispersed in the solution beforehand, a colloid shell is formed around it, and can be cured. In the case of complex coacervation, two materials having different electrical charges are combined with one another, with spontaneous formation of shells. One example of this is the established combination of gelatin and gum arabic. To the skilled person it is readily apparent that such colloidal solutions cannot be used to form particles having diameters of greater than 500 μm without an uncontrolled precipitation occurring. With this method, furthermore, the combinability of the individual components is severely limited. Complex coacervation has been described in, for example, GB 1,117,178 or McFarland et al. (Polymer Preprints, 2004, 45(1), p.1f).

For the preparation of relatively small particles, moreover, polymerization processes such as emulsion, interfacial or matrix polymerization are proposed. To the skilled person it is readily apparent that such methods can in fact be used only to produce very small particles having diameters of well below 500 μm, and the methods can be employed in each case only for specific combinations of material. NL 6414477, for example, describes an interfacial polycondensation in dispersion. The polycondensates are polyesters or polyamides. Such capsules, however, either are too permeable for the material enclosed within the core, or are too difficult to open again. Moreover, the encapsulation mechanism of a condensation polymerization in the presence of the reactive substance to be encapsulated is a complex and usually incomplete process.

One area of application for interfacial polymerizations which resemble such emulsion or suspension polymerization is the synthesis of biocompatible capsule materials for dental applications, for example. One example of this are shells of polyethyl methacrylate (Fuchigami et al., Dental Material Journal, 2008, 27(1), pp. 35-48). To the skilled person, however, it is readily apparent that such core-shell particles are difficult to open and have to be extremely small for any such applications confined only to small areas or compartments for application.

WO 02 24755 describes microparticles having particularly narrow, monomodal size distributions, comprising a polystyrene crosslinked with divinylbenzene. For this purpose, styrene is prepolymerized, with initial introduction of the crosslinker, and then is introduced dropwise, together with further initiators, in the interior of a coaxial nozzle, into an aqueous solution. These droplets are provided with an outer layer by means of a separating and protecting liquid which is added dropwise coaxially, and are size-stabilized as a result. Through addition of suitable components to the aqueous phase, this outer shell cures and protects the inner region during the radical curing operation. After synthesis, the outer protective shell is removed by washing or a similar operation. Although, there, protective shells are occasionally described for the encapsulation of reactive components, the systems in question are not in any way core-shell particles in the actual sense. Rather, these protecting liquid layers, based on polyethers and sodium alginate, are neither mechanically stable nor permeation-proof. Furthermore, of course, they are very thin and not storage-stable. The temporary stability during the curing of the microparticles is attributable to the character of the microparticles, which is polymeric after the prepolymerization.

The use of coaxial nozzles the synthesis of storage-stable, liquid-filled core-shell particles is described in Berkland et al. (Pharmaceutical Research, 24, no. 5, pp. 1007-13, 2007). Added dropwise via the coaxial nozzle are, viewed from inside to outside, the liquid phase to be encapsulated, a polymer solution from which the shell is formed, and a liquid which serves as a carrier stream and can be identical with the receiving liquid, and in the course of their introduction are torn apart beforehand by an amplifier to form droplets of analogous construction. The droplets are introduced dropwise into an aqueous polyvinyl alcohol solution, where the shell materials cure. The objective here is the synthesis of biodegradable particles for—for example—medical applications. Accordingly, the shell consists of degradable polymers such as polylactide-glycolide. The core is filled with solutions of an active medical ingredient, and not with a technical reactive substance such as initiators, crosslinkers, catalysts or accelerators. Correspondingly, the particles are also very small, below 200 μm. It is true that this is a method which does not have the drawbacks of a colloidal system and at the same time cures decidedly quickly without a polymerization step. Drawbacks for industrial applications, such as the encapsulation of reactive components, for example, are, however, the size and the mechanical instability of such organic materials. In addition, the opening mechanism of biodegradation is designed specifically for very slow release of active ingredient. With industrial applications, in contrast, there is often a need for simultaneous, rapid release of the reactive components.

### Problem

A problem addressed with the present invention is that of developing a process for providing core-shell particles, comprising reactive components, for a 1-component coating system—referred to for short below as 1-K system.

The problem more particularly is to provide core-shell particles which can be opened rapidly by an extremely simple mechanism. The core-shell particles ought more particularly to be able to be activated in such a way that the reactive component present in the core is released virtually completely within a very short time.

A further problem is that of providing a process for preparing core-shell particles that is simple to carry out and allows the preparation of particles having an adjustable diameter, greater than that of the prior art, and ideally a monomodal size distribution.

A problem more particularly is to provide a process by means of which core-shell particles comprising a reactive component can be prepared that are sufficiently stable for the coformulation and storage in viscous 1-K systems, of the kind used, for example, as a road marking composition, and at the same time can be opened with mechanical energy.

Other problems, not explicitly stated, will become apparent from the overall context of the following description, claims, and examples.

### Solution

The numbers in brackets refer to the appended drawing FIG. 1.

The problems are solved through the provision of an innovative encapsulation process for preparing core-shell particles. This innovative process is notable for the combination of various aspects, as follows.
a.) A coaxial nozzle (FIG. 1) is used to form a liquid jet consisting of two or three layers.
b.) The innermost (2a) of the two or three layers of the liquid jet is a reactive component which is present either as pure substance or, preferably, as a stable solution or dispersion.
c.) The middle (3a) or—when there are only two layers present—the outer layer is the solution of an inorganic component.
d.) In the case of three layers, the outermost layer (4a) is a solvent. This third layer is only present optionally.
e.) A means is used to form droplets (consisting of 2a+3a) from the jet in free fall. Droplet detachment is assisted by a frequency generator and an amplifier (together (1)).
f.) These droplets, formed in falling, fall into a solvent (6) which interacts with the inorganic component in such a way that said component is solidified.
g.) The solvent (6) into which the droplets fall comprises an additional component which prevents or retards the sedimentation of the resultant particles.

More particularly the problem has been solved such that the inorganic material is the aqueous solution of a silicate (3), preferably of sodium silicate. With particular preference, waterglass is formed therefrom on solidification by physical curing in a suitable solvent. Said solvent must be distinguished by effective miscibility with water, by its hygroscopic character, and at the same time by its nonsolvency for the silicate in solution in the aqueous part of the droplet, so that this silicate, directly after dropwise introduction into the solvent (6), shifts the equilibrium between the dissolved silicate and the dehydrogenated silicate in such a way that it cures spontaneously and thus forms the shell of a core-shell particle. Consequently, on interaction after the droplet has struck, said solvent acts like a drying agent for the aqueous solution of the inorganic material (3 or 3a). Solvents (6) contemplated for this purpose include preferably polar alcohols such as, for example, methanol, ethanol or n- or isopropanol; ketones such as acetone, for example; and aqueous solutions of salts, with a concentration and nature such that the inorganic component is no longer soluble and the water is removed from the waterglass shell which forms. The solvent is preferably an alcohol, more preferably ethanol.

The solvent, referred to hereinafter as receiving liquid (6), into which the droplets fall comprises an additional component, which prevents or at least retards the sedimentation of the resultant particles. This sedimentation-retarding or -preventing component is a thickener which is miscible with solvent, which is preferably a polar alcohol. It is also very important that the miscibility of the solvent with water and the insolubility of the inorganic component in the solvent are influenced by the addition of the thickener not at all, only minimally, or in such a way as to improve the precipitation of the inorganic component. The thickener may be, for example, carboxyvinyl polymers, such as, for example, Tego Carbomer® 340 FD. It is preferred to use between 0.01% by weight and 3% by weight, more preferably between 1% by weight and 2% by weight, of the thickener.

The liquid jet may optionally also be composed of three layers (2a, 3a and 4a). In the case of the additional, outer layer (4a), the carrier stream, this would be a solvent which is effectively miscible with the receiving liquid (6). Preferably it is the same solvent or same solvent mixture as is used as the receiving liquid (6). This optional carrier stream (4a) stabilizes the liquid jet and promotes droplet formation. Depending on the system, a carrier stream of this kind may influence the shape uniformity of the core-shell particles obtained.

One particular aspect in comparison to the prior art is the mass ratio between the core or its content and the shell. The shells must have a certain minimum thickness in order that they do not rupture, for example, during formulation, transport or other product-specific process steps, and release the reactive component prematurely. On account of the relative size of the particles, it is possible to provide particles which on the one hand have a sufficiently thick shell and on the other hand nevertheless have a core of a size such that a relatively large quantity of solution, dispersion or pure substance can be contained. In this way it is possible to realize core-shell particles which, after opening, leave behind a relatively small amount of shell material in the product matrix and are nevertheless so stable that, even on stirred incorporation into viscous compositions such as creams or reactive resins, in other words with introduction of shearing energies, they provide sufficient stability not to be opened. In accordance with the invention the shell possesses a thickness of between 30 and 1000 μm, preferably between 50 and 500 μm.

The relative size of the core-shell particles, with a shell consisting of an inorganic material, preferably of waterglass, is a further particular feature of the present invention. The core-shell particles have & particle size diameter of between not less than 100 μm, preferably not less than 300 μm, more preferably not less than 500 μm, and not more than 3000 μm, more preferably not more than 1500 μm. The particle size distribution is preferably monomodal.

Particle size in this specification is understood to be the actual average primary particle size. Since the formation of agglomerates is prevented, the average primary particle size corresponds to the actual particle size. The particle size additionally corresponds approximately to the diameter of a particle with a virtually spherical appearance. In the case of particles without a spherical appearance, the average diameter is determined as the average value formed from the shortest diameter and the longest diameter. By diameter in this context is meant a distance from one point on the edge of the particle to another such point. In addition, this line must cross through the center point of the particle.

The particle size can be determined by the skilled person with the aid, for example, of image analysis or static light scattering.

In the ideal scenario the core-shell particles are virtually spherical, or, synonymously, ball-shaped. The particles, however, may also have a rodlet, droplet, disk or beaker shape. The surfaces of the particles are generally round, but may also have intergrowths. As a measure of the geometrical approximation to the spherical form, an aspect ratio may be given, in a known way. In this case, the maximum aspect ratio occurring deviates by not more than 50% from the average aspect ratio.

The invention is suitable more particularly for preparing core-shell particles having a maximum average aspect ratio of not more than 3, preferably not more than 2, more preferably not more than 1.5. By the maximum aspect ratio of the particles is meant the maximum relative ratio which can be formed by two of the three dimensions of length, width, and height. In this context, the ratio of the largest dimension to the smallest of the other two dimensions is formed in each case. For example, a particle having a length of 150 μm, a width of 50 μm, and a height of 100 μm has a maximum aspect ratio (of length to width) of 3. Particles with a maximum aspect ratio of 3 may be, for example, short rodlet-shaped or else discus-shaped, tabletlike particles. Where the maximum aspect ratio of the particles is, for example, at most 1.5 or below, the particles have a more or less balllike or grainlike form.

Following dropwise introduction of the liquid jet into the solvent, and the curing of the shell that takes place therein, the particles are isolated and cleaned by filtration and optional washing of the particle surfaces with the same or a different solvent. Here it is important that residues of the reactive component are removed as completely as possible from the shell surface. This is followed by washing with a solvent or solution which is reactive for the reactive component, in order to verify the impermeability. In the case of peroxides, for example, methyl methacrylate can be used.

In the course of this processing, the primary particles may interact in such a way as to form adhered concretions, which may consist of up to 20 or 30 primary particles. In general, these concretions can be separated partly again into primary particles by gentle mechanical treatment, without the shells opening. These concretions are not aggregates in the conventional sense, in which the individual primary particles have intergrown with one another.

In order to counteract adhered concretion toward the end of the processing and/or in storage, the core-shell particles may be treated additionally by powdering, with Aerosil (from Evonik Degussa), for example. The powdering likewise acts as a drying agent. There are various processes for applying the powdering. Examples include the introduction of the powder material in the solvent in the course of curing, an additional washing step with a powder-containing dispersion, such as in ethanol or MMA, for example, or dusting of the dry particles in, for example, a drum or a stream of air.

The core of the core-shell particles comprises an active ingredient, preferably a liquid solution or dispersion of a reactive component, and more preferably a dispersion of a peroxide in an oil.

The oil used may be, for example, Drakesol 260 AT, Polyoel 130, and Degaroute W3, more preferably Dagaroute W3 from Evonik Röhm GmbH. In order to ensure that the oil no longer contains any water, it may be dried prior to use, as for example by thermal treatment in a drying oven. The curing of waterglass, for example, is quicker and more effective if the included oil is water-free.

In this specification, unless stated otherwise, the expression “reactive component” is to be viewed as equivalent with the term “active ingredient”. An active ingredient is a substance which brings about a desired effect following its release. The substances in question may be as different as, for example, dyes, pigments, including effect pigments, or thickeners in paint or coatings applications. They may also be vitamins, flavors, animal nutritional supplements, trace elements or other additives for foods or animal nutrition, which would not be stable under normal storage conditions. They may additionally be flavors, aromas or active ingredients for cosmetic applications, of the kind that may be employed, for example, in creams, toothpastes, hair care products, soaps or lotions. They may also, for example, be active medical ingredients in medicaments for controlled release.

With particular preference, the reactive component contained in the core-shell particles of the invention comprises initiators, accelerators or catalysts, more preferably initiators, accelerators or catalysts for the curing of 1-K systems.

Where the reactive component is an initiator, it is preferably a radical initiator, more preferably an organic peroxide. Examples of such peroxides, without thereby restricting the invention in any form whatsoever, are lauroyl peroxide or benzoyl peroxide.

The said accelerators may be, for example, amines, preferably aromatically substituted tertiary amines. Examples, again without restrictive character, are N,N-dimethyl-p-toluidine, N,N-bis(2-hydroxyethyl)-p-toluidine or N,N-bis(2-hydroxypropyl)-p-toluidine.

For the release of the reactive component, the core-shell particles of the invention are ruptured by exposure to pressure or any other form of mechanical energy. This mechanical energy may be introduced, for example, in the form of one-, two- or three-dimensionally exerted pressure, shearing, puncturing, squeezing, rubbing, sprayed application to a hard surface, or fluidizing. Introduction of this energy ruptures the core-shell particle and releases the active ingredient. The form of this mechanical introduction of energy is freely selectable and is not such as to restrict the invention in any way. Alternatively, the core-shell particle of the invention can also be opened by addition of a suitable solvent, more particularly by addition of water.

Not suitable for the opening of the core-shell particles, in contrast, are conventional radiation, thermal energy below the reaction point of the reactive component, or chemical influencing by means, for example, of organic solvents, oxidizing agents or a change in polarity. The advantage of the particles of the invention, rather, is that they are particularly stable in the face of such ambient factors. This facilitates the processing, storage, and transport of formulations comprising the particles of the invention.

The core-shell particles of the invention can be employed in a very wide variety of areas of application, with no intention that the following examples can be understood as in any way restrictive with regard to their use.

The core-shell particles filled with an initiator, catalyst or accelerator are used preferably in reactive resin mixtures, intended for example for road marking, for the laying of floors, in bridge building or for rapid prototyping. Such particles may also be used, however, in sealants, chemical anchors, adhesives or other coatings.

Core-shell particles filled with reactive substances—such as monomers, for example—may be used in self-healing materials.

Particles filled with dyes may be used in effect paints or in coatings or moldings in safety engineering, for the detection, for example, of pressures, stresses or instances of material fatigue.

Particles filled with active ingredients may find use in, for example, cosmetics, medicine or animal nutrition.

### DESIGNATIONS FROM THE DRAWING FIG. 1

FIG. 1 Coaxial nozzle

(1) Frequency generator and amplifier
(2) Initial introduction of the reactive component (pure substance, solution or dispersion)
(2a) Pump for conveying (2)
(2b) Component (2) in the liquid jet or in the droplet
(3) Initial introduction of the solution of the inorganic component
(3a) Component (3) in the liquid jet or in the droplet
(insoluble in (4a))
(3b) Pump for conveying (3)
(4) Initial introduction of the solvent for the optional carrier stream
(4a) Carrier stream (optional)
(4b) Pump for conveying (4)
(5) Lamp
(6) Receiving liquid or solvent
(7) Stirrer bar
(8) Magnetic stirrer
(9) Receiving vessel (glass beaker)

### EXAMPLES

### Apparatus

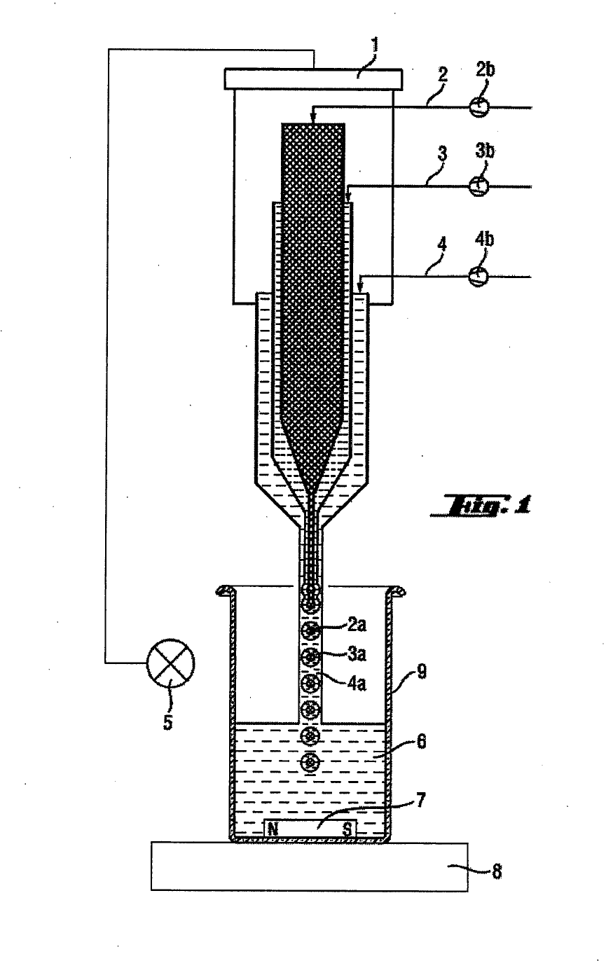

The numbers in brackets refer to the appended drawing FIG. 1.

### Rheometer: Haake RheoStress 600

Measuring body: Plate (solvent trap)/cone, DC 60/2°
Sample vessel contents: 5.9 ml sodium silicate solution
Measuring temperature: 23.0° C.
Measurement: after 120 s at 500 revolutions per s
Frequency generator: Black Star 1325 and Jupiter 2000 (1)
Transformer: Heinzinger LNG 16-6 (or similar device) (1)

### Lamp (5): Drelloscop 2008

### Pumps:

Piston membrane pump+pulsation attenuator: LEWA EEC 40-13 (2b)
Gear pump: Gather CD 71K-2 (3b)
   Flow rate through pumps: for 350/500 μm nozzles
Piston membrane pump+pulsation attenuator for sodium
   silicate solution: 1.5-5 l/h
Gear pump for initiator-oil suspension: 1-2 l/h

### Pretreatment of the Sodium Silicate Solution

1.3 l of commercial sodium silicate solution having a solids content of 40% by weight and a dynamic viscosity of 110 mPas are introduced into a crystallizing dish having a diameter of 19 cm. Stirring is carried out using a magnetic stirrer with stirrer bar (length: 2 cm). Stirring must always be very vigorous, so that the entire surface is in motion and a distinct stirring funnel is formed. After 24 hours, the viscosity is measured in the rheometer with a plate/cone system (DC)60/2°. Where appropriate, subsequent dilution or further drying takes place to a solids content of 45% by weight. In the course of this operation, there is an increase in the dynamic viscosities from 110 mPas to 310 mPas.

### Preparation of the Initiator Suspension

For preparing the suspension, a 500 ml sample bottle is taken and is filled with Degaroute W3. Then 20% by weight of BPO 75 (benzoyl peroxide, hereinafter BPO for short) is added cautiously in steps. BPO floating on the surface is stirred in using a wooden spatula. For subsequent processing, the suspension is treated in an icebath using an Ultraturrax (alternatively ultrasound). 1 minute at level one, 10 minutes at level two, and lastly 3 minutes at level three.

### Process Instructions—Preparation of Peroxide-Filled Particles

The sodium silicate solution (3) and the initiator suspension (2) comprising BPO and Degaroute W3 are introduced into the corresponding reservoir containers. The frequency generator (1) and the light source (5) are switched on with a frequency of 16 kHz. Then the pumps for the sodium silicate solution (3b) and the suspension (2b) are switched on at the same time, and a continuous flow is set. The receiving vessel (9) used is a 600 ml glass beaker having an internal diameter of 7.6 cm. It contains 300 ml of the receiving medium (6), consisting of technical ethanol and Tego Carbomer 340 FD in a ratio of 100 to 1.5. The receiving medium is stirred by means of a magnetic stirrer (8) and a stirrer bar (7), with a stirring speed of between 650 and 1200 revolutions per minute. The height of dropwise introduction between nozzle head and receiving medium is 16 cm. Dropwise introduction is not commenced until a funnel has formed as a result of the stirring. Every 2 to 3 minutes, when the solution is saturated, the glass beaker is replaced by another, containing fresh receiving medium.

The receiving solutions comprising particles are combined and the particles are filtered off on a sieve with a pore size of less than 500 μm. The particles are then washed first with technical ethanol and subsequently with methyl methacrylate. Between the individual washing operations, the particles are air-dried in each case. The washed and dried particles, lastly, are admixed with 1% by weight of Aerosil 200.

Results table:

| | Nozzle | Diameter |
|---|---|---|
| Example | in μm | in μm |
| 1 | 350/500 | 1731 |
| 2 | 250/350 | 1718 |
| 3 | 150/350 | 845 |

The diameters were determined microscopically using an image analysis.

### Investigation of Storage Stability

Two 20 ml glass vessels with snap-shut lids are each filled to one third with the core-shell particles from examples 1 to 3, and made up with MMA. In each case, one of the glass vessels is stored at room temperature, the other at 40° C. After storage for one, two, and three weeks in each case, a check is made as to whether there has been any marked increase in viscosity, or even solidification of the MMA. In addition a check is made as to whether the particles have changed in terms of size, shape, and color.

In none of the examples was there any polymerization or an increase in viscosity within the three weeks. In a comparative test, the particles are destroyed by pressing with a spade, and an observation is made, at room temperature, of the time after which the formulation is no longer fluid. All of the samples were no longer fluid, i.e., had cured, after 7 to 8 minutes.

1. A process for preparing a core-shell particle, the process comprising:
forming a liquid jet with a coaxial nozzle, the liquid jet consisting of an innermost layer, a second layer, and optionally, a third layer,
forming droplets from the jet in free fall, and
interacting the droplets in a solvent that interacts with an inorganic component of the second layer of the jet in such a way that the inorganic component solidifies,
wherein the innermost layer of the jet is a stable solution or dispersion of a reactive component,
the second layer of the jet is a solution of the inorganic component,
the optional third layer of the jet, if present, is the outermost layer and is a solvent, and
the solvent that interacts with the organic component comprises an additional component that prevents or retards sedimentation of the particle.

2. The process of claim 1, wherein the inorganic component is an aqueous solution of a silicate.

3. The process of claim 1, wherein the reactive component is an initiator, accelerator, or catalyst for curing a 1-K (1-component) system.

4. The process of claim 3, wherein the reactive component is a radical initiator.

5. The process of claim 1,
wherein the solvent that interacts with the inorganic component is a drying agent for the solution of the inorganic component, and
the solution of the inorganic component is an aqueous solution.

6. The process of claim 5, wherein the solvent is an alcohol.

7. The process of claim 5,
wherein the third layer is present in the jet, and
the solvent of the third layer is the solvent that interacts with the inorganic component.

8. The process of claim 1 wherein the additional component that prevents or retards sedimentation is a thickener that is miscible with an alcohol.

9. A core-shell particle obtained by a process comprising the process of claim 1,
wherein a shell of the particle consists of inorganic material,
the particle has an average aspect ratio of not more than 3 and a particle size of at least 100 μm and not more than 3000 μm, and
a core of the particle comprises a liquid solution or dispersion of a reactive component.

10. The core-shell particles particle of claim 9,
wherein the shell consists of waterglass,
the particle has an average aspect ratio of not more than 2 and a particle size of at least 500 μm and not more than 3000 μm, and
the core comprises a dispersion of a peroxide in an oil.

11. The core-shell particle of claim 9, wherein the shell has a thickness of between 30 and 1000 μm.

12. The core-shell particle of claim 9,
wherein pressure or another form of mechanical energy is capable of rupturing the shell, and
rupturing the shell releases an active ingredient.

13. The process of claim 2, wherein the silicate comprises sodium silicate.

14. The process of claim 13, wherein the sodium silicate forms waterglass.

15. The process of claim 4, wherein the radical initiator comprises an organic peroxide.

16. The process of claim 6, wherein the alcohol is methanol, ethanol, n-propanol, isopropanol, or a mixture thereof.

17. The process of claim 16, wherein the alcohol is ethanol.

18. The core-shell particle of claim 11, wherein the shell has a thickness of between 50 and 500 μm.

19. The core-shell particle of claim 9, wherein the particle size is at least 500 μm and not more than 1500 μm.

20. The process of claim 6,
wherein the third layer is present in the jet, and
the alcohol is the solvent that interacts with the inorganic component.
